(19) United States
(12) Patent Application Publication
(10) Pub. No.: US 2013/0341992 A1
(43) Pub. Date: Dec. 26, 2013

(54) ARTICLE OF FURNITURE

(71) Applicants: David King, New South Wales (AU); Ryan Lawson, New South Wales (AU)

(72) Inventors: David King, New South Wales (AU); Ryan Lawson, New South Wales (AU)

(73) Assignee: KING FURNITURE (AUSTRALIA) PTY LTD, NSW (AU)

(21) Appl. No.: 13/996,977

(22) PCT Filed: Dec. 15, 2011
(86) PCT No.: PCT/AU11/01623

§ 371 Date: Sep. 9, 2013

(30) Foreign Application Priority Data
Dec. 23, 2010 (AU) 2010905640

(51) Int. Cl. A47C 7/02; F16B 12/00

(52) U.S. Cl. CPC A47C 7/02; F16B 12/00
USPC 297/452.18; 403/361

(57) ABSTRACT

An article of furniture (10) comprises a seat portion (12) having a frame (14) and upholstery covering the frame (14). The upholstery includes cushioning and a covering (18a, 18b) overlying the cushioning. At least one opening (20) is defined in the covering of the upholstery. The at least one opening (20) is configured to receive a component of a connector arrangement (22) to attach a removable module to the frame (14). A disguising member disguises the at least one opening (20), the disguising member being configured as a feature of the upholstery.

### CROSS-REFERENCE TO RELATED APPLICATIONS

The present application claims priority from Australian Provisional Patent Application No. 2010905640 filed 23 Dec. 2010, the contents of which are incorporated in this specification by reference in their entirety.

### FIELD

The present disclosure relates to an article of furniture and, more particularly, to an article of convertible furniture. The term “convertible” is to be understood to mean that the article of furniture can be converted to serve different purposes, including forming a module of modular furniture.

### BACKGROUND

Convertible furniture has many benefits, such as the ability to reconfigure the furniture based on space constraints, to serve different purposes or for aesthetic reasons, along with the ability to separate units of the furniture to facilitate transport and storage. However, generally, whether applicable to modular furniture or not, each unit of furniture is typically restricted to a particular use. For example, a corner unit of a modular lounge suite is configured only for use as a corner unit; a chaise is configured only for use as a chaise, and so on. These restrictions limit the ability to reconfigure a suite of furniture.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

In an aspect, there is provided an article of furniture comprising:
a seat portion having a frame and upholstery covering the frame, the upholstery including cushioning and a covering overlying the cushioning;
at least one opening defined at least in the covering of the upholstery, the at least one opening being configured to receive a component of a connector arrangement to attach a removable module to the frame; and
a disguising member disguising the at least one opening, the disguising member being configured as a feature of the upholstery.

More particularly, the disguising member may be a feature of the covering of the upholstery. The disguising member may be selected from the group consisting of: a seam, a button and buttonhole, an eyelet, a belt loop, a zip and a strap.

Where the disguising member is a seam, the covering of the upholstery may define an overlapping portion having an outer layer and an inner layer so that, at least at a part of the overlapping portion, the outer layer is not stitched to the inner layer so that the opening is an aperture in the covering, the aperture being covered by the outer layer. The hidden aperture may communicate with a bore in the cushioning through which the component of the connector arrangement extends to attach the removable module to the frame.

The outer layer and the inner layer may be biased towards each other to facilitate displacement of the outer layer over the inner layer to hide the aperture upon removal of the component of the connector arrangement. Biasing of the outer layer and the inner layer may be effected by use of an elasticized tab, a polymeric insert, a resiliently flexible metal insert, or the like.

The article of furniture may include a retention arrangement carried by the covering for retaining the outer layer over the inner layer when the component of the connector arrangement is absent. The retention arrangement may be a hook-and-loop system, such as that known by the registered trade mark, Velcro, applied to the outer layer and the inner layer.

The article of furniture may include at least one removable module and a connector arrangement associated with each removable module. The removable module may comprise an item selected from the group consisting of: a back module, a side module, an armrest module, a table module, a rack module, a corner module, a back cushion module, an arm cushion module, or the like. The, or each, module may have a frame member associated with it.

The connector arrangement may comprise at least one component, in the form of a connector, for interconnecting the frame of the seat portion and the frame member of the relevant module. The connector arrangement may comprise at least two connectors which, in use, are arranged in spaced relationship relative to each other.

The connector may be elongate, having a first arm, an opposed second arm and an intermediate, bridging portion between the first arm and the second arm. In an embodiment, the first arm and the second arm of the connector may extend longitudinally and substantially parallel to each other and the bridging portion of the connector may extend transversely with respect to the arms to form a cranked element. Accordingly, the first and second arms of the connector may be transversely offset with respect to each other. Moreover, in use, with one of the arms of the connector received in the frame, the other arm of the connector may be transversely offset outwardly of the frame, with the bridging portion of the connector extending through the opening in the covering of the upholstery.

The frame may be a box frame and may comprise frame elements extending generally parallel to a first plane, which, in use, is a substantially horizontal plane, and frame elements extending generally perpendicularly to the first plane. The frame elements of the frame may be tubular.

Similarly, the frame member of each module may be a tubular metal frame.

In an embodiment, the frame of the seat portion and the frame member of the module may contain socket defining members which define sockets for receiving the arms of the connector. In another embodiment, the frame of the seat portion and the frame member of the module define sockets for receiving the arms of the connector. It will be appreciated that both sockets in the frame and the frame member and the socket defining members may be provided together if desired or necessary. An inlet to each socket defining member may be flared or contain a flared collar to aid in insertion of the relevant arm into a socket of its associated socket defining member.

In an embodiment, the socket defining members may extend substantially perpendicularly to the first plane of the frame. Thus, with an arm of each connector received in its associated socket defining member, the arms of the connectors may extend substantially perpendicularly to the first plane and the bridging portions may extend substantially parallel to the first plane. The aperture in the covering and the bore in the cushioning of the upholstery may extend generally parallel to the first plane.

In an embodiment, the socket defining members may be arranged at an angle to the first plane of the frame. An outer periphery of the collar of each socket defining member may lie in a plane substantially perpendicular to a longitudinal axis of the socket. Instead, an outer periphery of the collar may lie in a plane substantially perpendicular to the first plane of the frame of the seat portion.

The collar may be flexible to deform when a force is applied to it. The collar may be of a synthetic plastics material and may be configured to have variable stiffness characteristics to deform in a predetermined manner when the force is applied to it and to return to its undeformed configuration when the force is removed.

In an embodiment, each connector may comprise a first member, in the form of a pin, a second member, in the form of a tongue, and an intermediate, bridging portion arranged between the first member and the second member. The bridging portion may comprise a contoured part, which may be a curved part, to follow a contour of a part of the seat portion. The part of the seat portion may be an upper part of the seat portion where a top of the seat portion meets a side of the seat portion.

The bridging portion may further include a substantially planar part from which the pin extends. The pin may extend at a predetermined obtuse angle from the planar part of the bridging portion. In an embodiment, the pin may be mounted via a bracket on the planar part of the bridging portion. The bracket may be configured to fit in the opening of the covering such that distortion of the covering when the pin is inserted into the opening is minimised. In another embodiment, the pin may be fabricated to have a head configured to accommodate a part of the covering of the article of furniture to inhibit distortion of the covering.

The pin of the connector may be shaped to inhibit rotation relative to the socket in which it is received. Thus, for example, a free end of the pin may be shaped to have a flat surface which bears against a correspondingly flat surface in the socket in which it is received. In addition, or instead, the pin and the socket may have a transverse, cross-sectional shape which inhibits rotation, for example, an elliptical shape, a polygonal shape, or the like.

In another aspect, there is provided a component for an article of modular furniture, the component including
an elongate tubular element defining a socket in which a spigot is receivable; and
a collar arranged at an entrance opening to the tubular member, the collar being flexible to deform in a predetermined manner when a force is applied to it.

The collar may be of a synthetic plastics material and is configured to have variable stiffness characteristics to deform in a predetermined manner when the force is applied to it and to return to its undeformed configuration when the force is removed.

### BRIEF DESCRIPTION OF DRAWINGS

Embodiment of an article of furniture will now be described, by way of example only, with reference to the accompanying drawings, in which:

FIG. 1 shows a perspective view of a seat portion of an embodiment of an article of furniture;

FIGS. 2a-2d show perspective views illustrating the process for attaching a connector to a frame of the seat portion of FIG. 1;

FIGS. 3a-3d show perspective views of the seat portion of FIG. 1 and a removable back module, with upholstery removed to show the frames of the seat portion and the back module, illustrating the process for attaching the back module to the seat portion, with FIG. 3d being an enlarged view of the circled portion of FIG. 3c;

FIG. 4 shows a perspective view of the article of furniture including a back module and a side module attached to the seat portion to form a corner unit;

FIG. 5 shows a perspective view of the article of furniture with only a back module attached to form a chair or the centre portion of a modular sofa;

FIG. 6 shows a perspective view of the article of furniture with a back module and two side modules attached to form an armchair;

FIGS. 7a-7b show perspective views of another embodiment of the article of furniture, more specifically a frame of a seat portion and a frame member of a module of the article of furniture with FIG. 7b showing an enlarged view of the circled portion of FIG. 7a;

FIGS. 8a-8c show perspective views of the manner of attaching the module to the seat portion of the article of furniture;

FIG. 9 shows a rear view of the article of furniture illustrating the openings into which the connectors are inserted for attaching the module to the seat portion;

FIG. 10 shows a perspective view of the article of furniture in the form of a chair including a backrest module;

FIG. 11 shows a perspective view of the chair including a backrest module and a single armrest module;

FIG. 12 shows a perspective view of the chair including a backrest module and two armrest module;

FIG. 13 shows a perspective view of the article of furniture in the form of a sofa including two backrest modules and two armrest modules;

FIG. 14a shows a perspective view of a seat portion of a further embodiment of an article of furniture;

FIG. 14b shows, front view, on an enlarged scale, of the part of the article of furniture encircled by Circle ‘A’ in FIG. 14a of the drawings;

FIGS. 15a-15b show perspective views of an embodiment of the article of furniture similar to the embodiment of FIGS. 7a-7b;

FIGS. 16a-16c show perspective views of the manner of attaching the module to the seat portion of the article of furniture of the embodiment of FIGS. 15a-15b;

FIGS. 16d and 16e show, on an enlarged scale, two alternative embodiments of the circled part of FIG. 16b;

FIG. 17a shows a perspective view of yet a further embodiment of an article of furniture;

FIGS. 17b and 17c show, respectively, a collar of a socket defining member of the article of furniture in an undisturbed, undeformed condition and how the collar is deformed, in use, by the application of a force;

FIG. 18 shows a perspective view of an embodiment of a connector for the embodiment of the article of furniture of FIGS. 7a-7b;

FIG. 19 shows a front view of the connector of FIG. 18;

FIG. 20 shows a bottom view of the connector of FIG. 18; and

FIG. 21 shows a side view of the connector of FIG. 18.

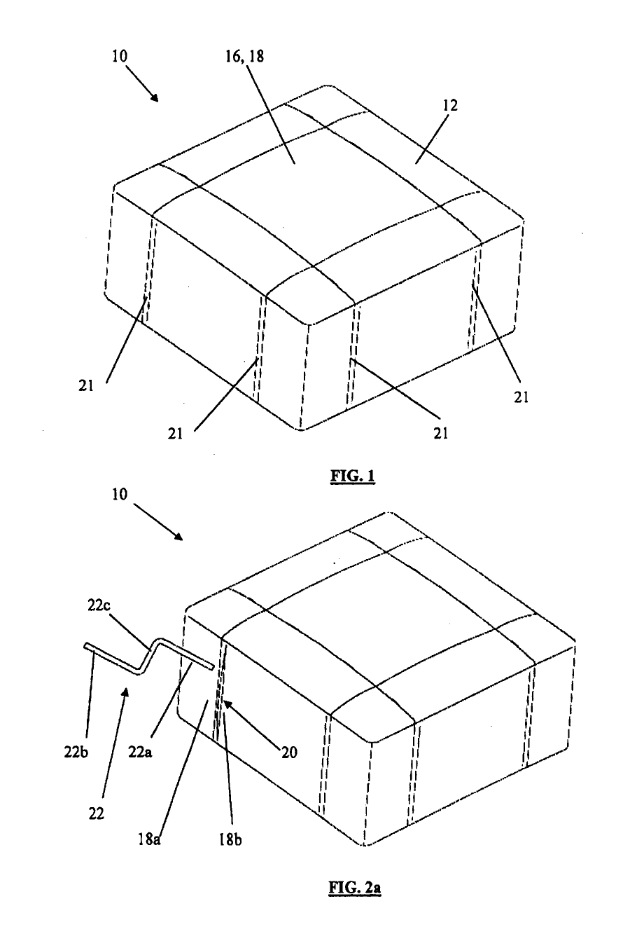

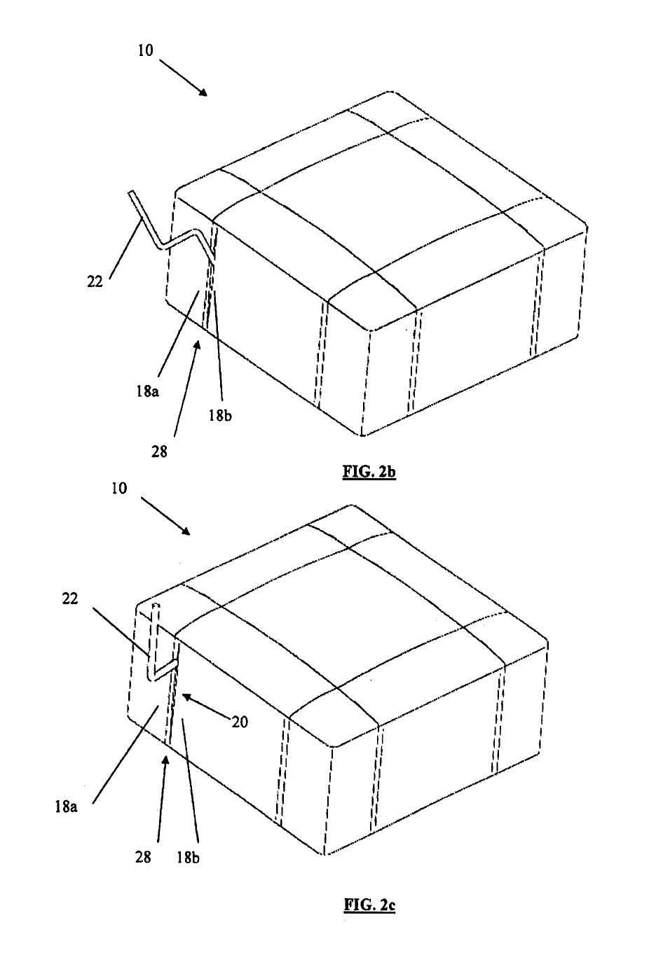

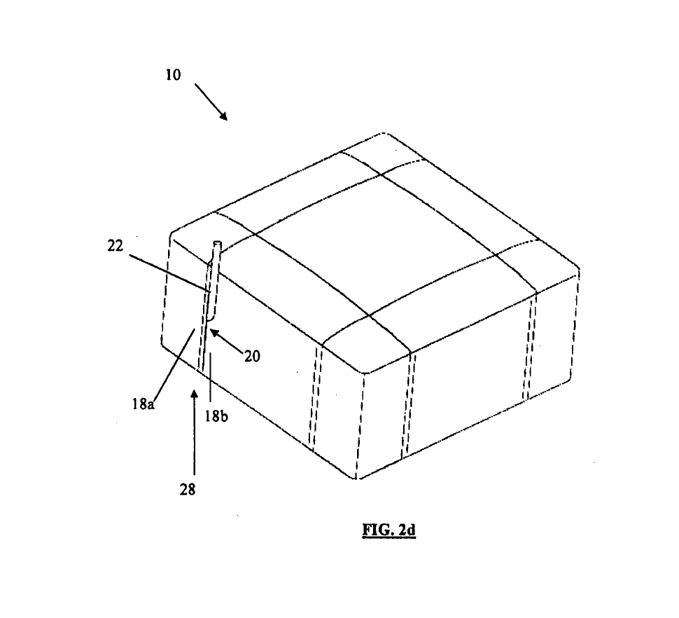

### DETAILED DESCRIPTION OF EXEMPLARY EMBODIMENTS

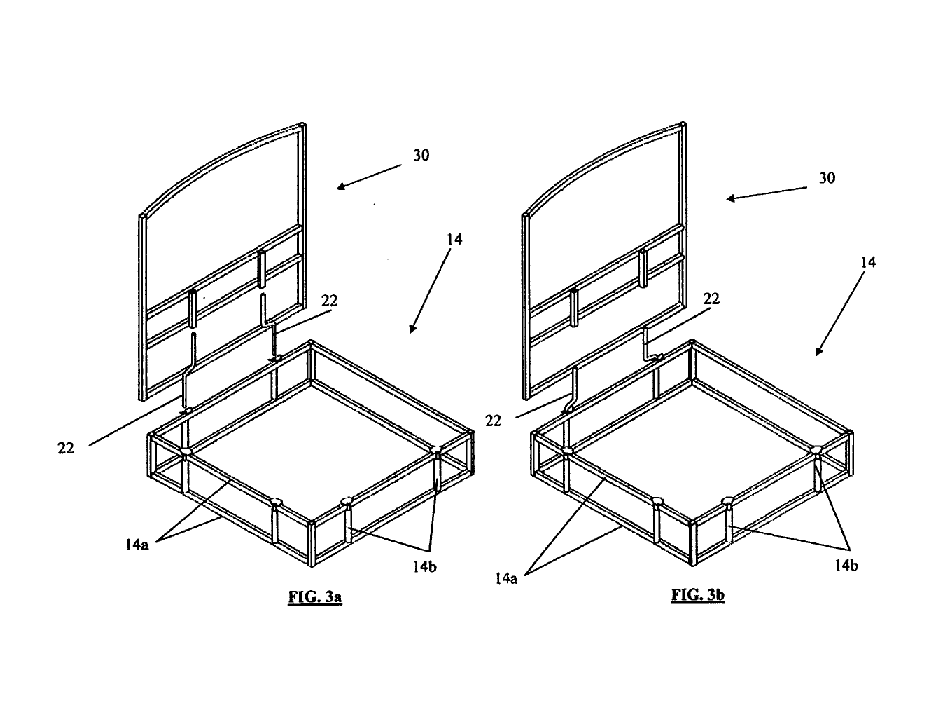

In the drawings, reference numeral 10 generally designates an article of furniture in the form of a modular lounge unit 10. The lounge unit 10 includes a seat portion 12, which may be used as an ottoman, having a frame 14 (FIG. 3) and upholstery 16 covering the frame 14. The upholstery 16 comprises a cushioning layer and a covering 18. The covering 18 of the upholstery 16 defines openings 20 for receiving components, in the form of connectors 22, of a connector arrangement to attach removable modules, in the form of back modules 24 or side modules 26, to the frame 14. The lounge unit 10 includes a disguising member for disguising each opening 20 as a feature of the covering 16 of the upholstery 18 and, in the illustrated embodiment, the disguising member is defined by a portion 28 of a seam 21 in the covering 18.

Each seam 21 is defined by the overlapping portions 28 of material of the covering 18, the overlapping portions 28 being defined by an outer layer 18a and an inner layer 18b. In a part of the overlapping portions 28, the outer layer 18a of material is not stitched to the inner layer 18b so as to be displaceable from inner layer 18b to expose the opening 20. The properties of the material of the covering 18 and the structure of the seam 21 are such as to bias the layers 18a and 18b into overlapping relationship to disguise the presence of the opening 20 in the seam 21. It will be appreciated that, instead of the disguising member being in the form of the layers 18a and 18b, the disguising member which disguises and/or conceals the opening 20 could be a button and buttonhole arrangement, an eyelet, a belt loop or buckle, or the like.

The portion 28 of the outer layer 18a forming the seam 21 may be biased by having a resiliently flexible element (not shown) contained in the portion 28. The resiliently flexible element is, for example, a strip of plastics material, a strip of metal material, or the like. Instead, the material of the overlapping portion 28 of the outer layer could be resiliently flexible to adopt a position closing off the opening 20.

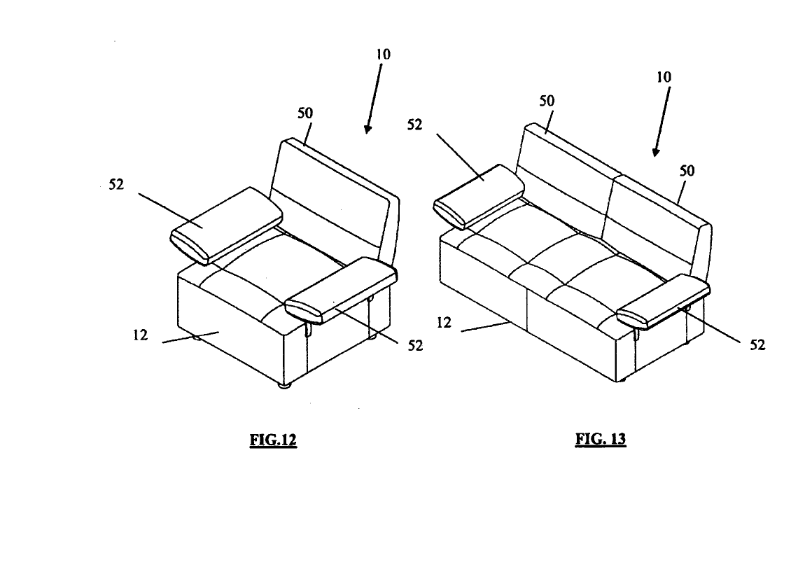

As shown in FIGS. 14a and 14b, a retention arrangement 23 for retaining the overlapping portion 28 of the outer layer 18a in position over the inner layer 18b to conceal and disguise the opening 20. In the illustrated embodiment, the retention arrangement 23 comprises complementary strips 25 of a hook-and-loop fastening system, such as, for example, that sold under the registered trade mark, Velcro. One of the strips (not shown) is carried on an operatively inner surface of the overlapping portion 28 of the outer layer 18a with the other strip 25 being carried on an operatively outer surface of the inner layer 18b. Hence, when the connector 22 has been removed from the opening 20 and the overlapping portions 28 overlap to conceal and disguise the opening 20, the strips of hook-and-loop fasteners engage to retain the overlapping portions 28 in overlapping relationship. It will be appreciated that other retention mechanisms could be used such as, for example, press studs, buttons and buttonholes, or the like.

Each connector 22 is elongate having a first arm 22a, an opposed second arm 22b and an intermediate, bridging portion 22c between the first arm 22a and the second arm 22b. The first arm 22a and the second arm 22b of the connector 22 extend generally longitudinally and the intermediate portion 22c of the connector extends generally transversely with respect to the arms 22a and 22b of the connector 22. Accordingly, the first arm 22a and the second arm 22b of the connector 22 are transversely offset with respect to each other. Moreover, in use, with the arm 22a of a connector received in the frame 14, the other arm 22b of the connector 22 is transversely offset outwardly of the frame 14 and stands proud of the frame 14. The bridging portion 22c of the connector 22 extends through its associated opening 20 in the covering 18 of the upholstery 16.

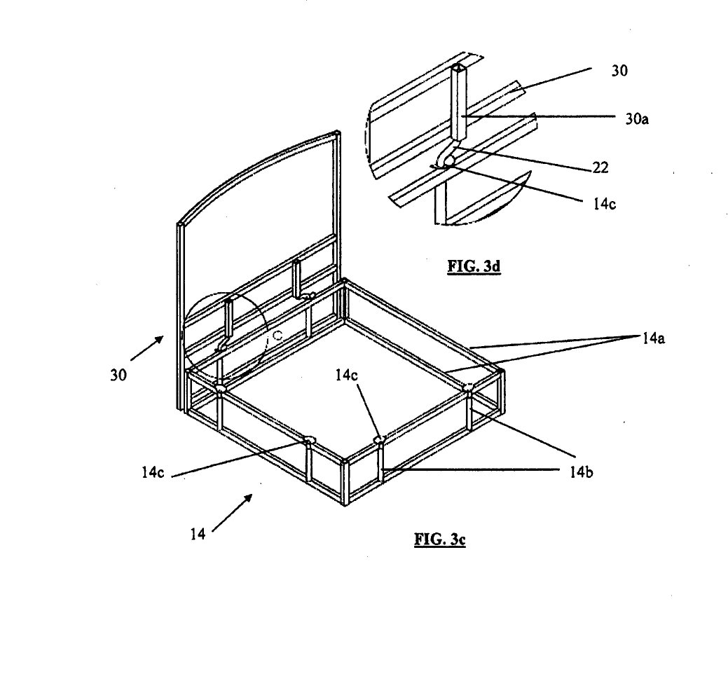

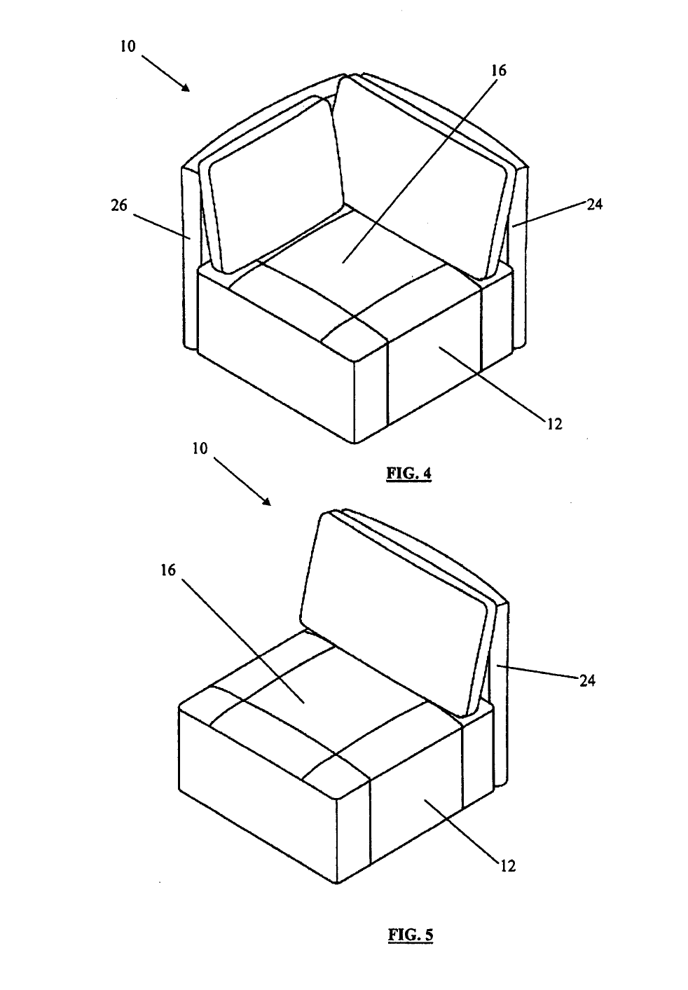

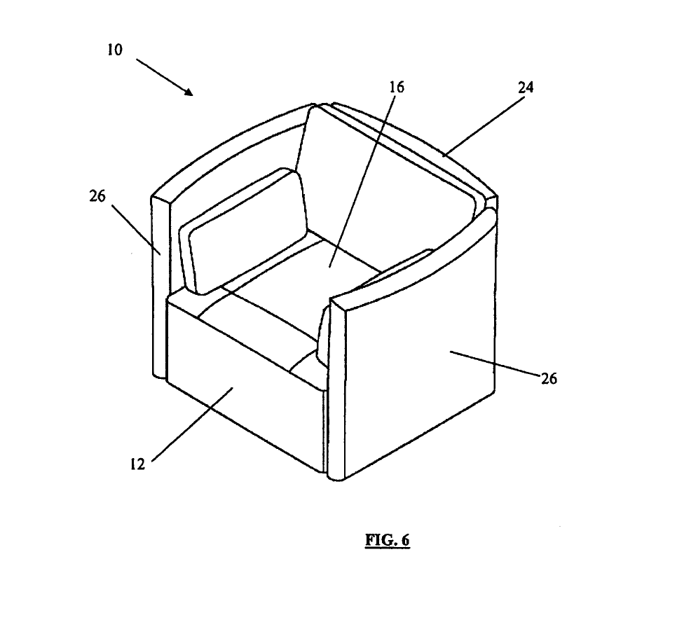

Each connector 22 extends through one of the openings 20 to attach a module such as a back module 24 (FIGS. 4-6) or a side module 26 (FIGS. 4 and 6) to the frame 14 of the seat portion 12. Upon removal of the connector 22 from its associated opening 20, the layers 18a and 18b revert to an overlapping relationship to conceal the presence of the opening 20 thereby improving the aesthetics of the seat portion 12.

Each of the back modules 24 and the side modules 26 includes an internal frame member 30. A pair of connectors 22 connects and secures the frame member 30 of the back module 24 or the side module 26, as the case may be, to the frame 14 of the seat portion 12.

The frame 14 comprises a lower set and an upper set of frame elements 14a, each set lying in a first planar configuration, which, in use, is a substantially horizontal plane, and frame elements 14b extending generally perpendicularly to the first plane. Each frame element 14b (apart from the corner frame elements 14b) is, or contains, a socket defining member which defines a socket in which the arm 22a of the relevant connector 22 is receivable. The socket defining members have a flared opening defined by a collar 14c to aid guiding the arm 22a of the connector 22 into the socket of the socket defining member of the frame element 14b.

In use, with an arm 22a of a connector 22 received in its associated frame element 14b of the frame 14, the arms 22a, 22b of the connector 22 extend generally perpendicularly to the first plane and the bridging portion 22c extends generally parallel to the first plane. Each opening 20 in the covering 18 and a passage (not shown) in the cushioning of the upholstery 16, the passage being in register with the opening 20 and through which the bridging portion 22c of the connector 22 extends, extend generally parallel to the first plane.

The frame 14 and the frame member 30 are tubular steel frames. Each frame member 30 also includes frame elements 30a. Each frame element 30a is tubular and defines a socket into which the arm 22b of one of the connectors 22 is insertable.

It will be appreciated that the illustrated lounge unit 10 has the advantage that it can be readily adapted for various uses by adding or removing back modules 24 or side modules 26. For example, with one back module 24 and one side module 26 attached to adjoining sides of the seat portion 12, the lounge unit 10 is able to be used as a corner unit in a modular lounge suite, as shown in FIG. 4. With a single back module 24 attached, the lounge unit 10 is able to be used as an intermediate unit in a modular sofa or as an armless chair, as shown in FIG. 5. With two side modules 26 and one back module 24 attached, the lounge unit 10 is able to be used as an armchair, as shown in FIG. 6.

It is to be noted in the illustrated embodiments that socket defining members are provided on only three sides of the frame 14 with the intention that one back module and one or two side modules could be employed in various configurations. However, it will be appreciated that socket defining members could be provided on a greater or fewer number of sides of the frame 14. Thus, although not illustrated, socket defining members could be provided on all four sides of the frame 14 and with two back modules 24 and two side modules 26 attached, the lounge unit 10 is able to be used as a crib for an infant.

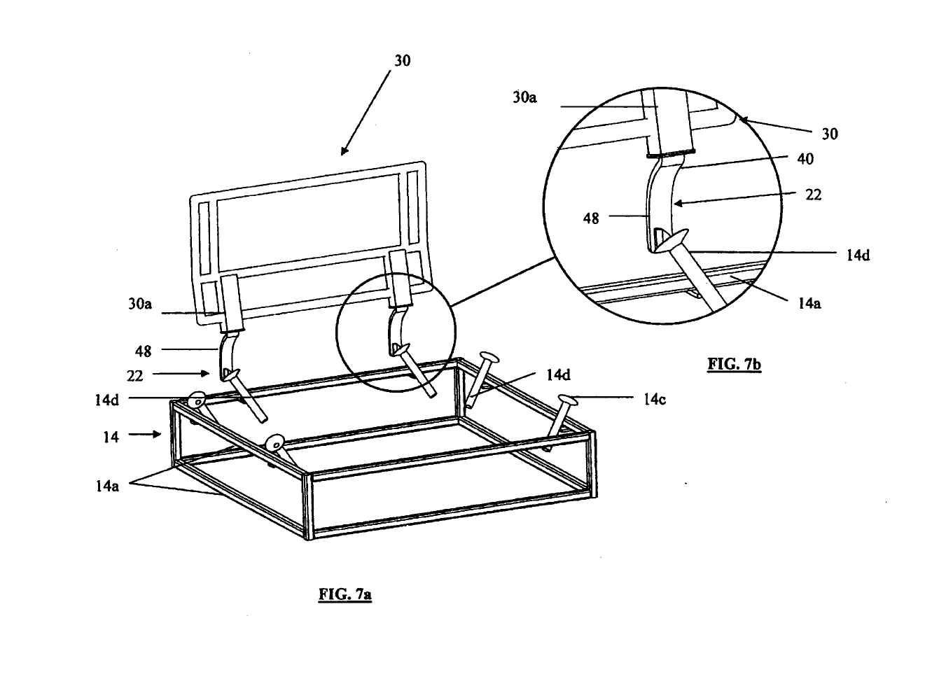

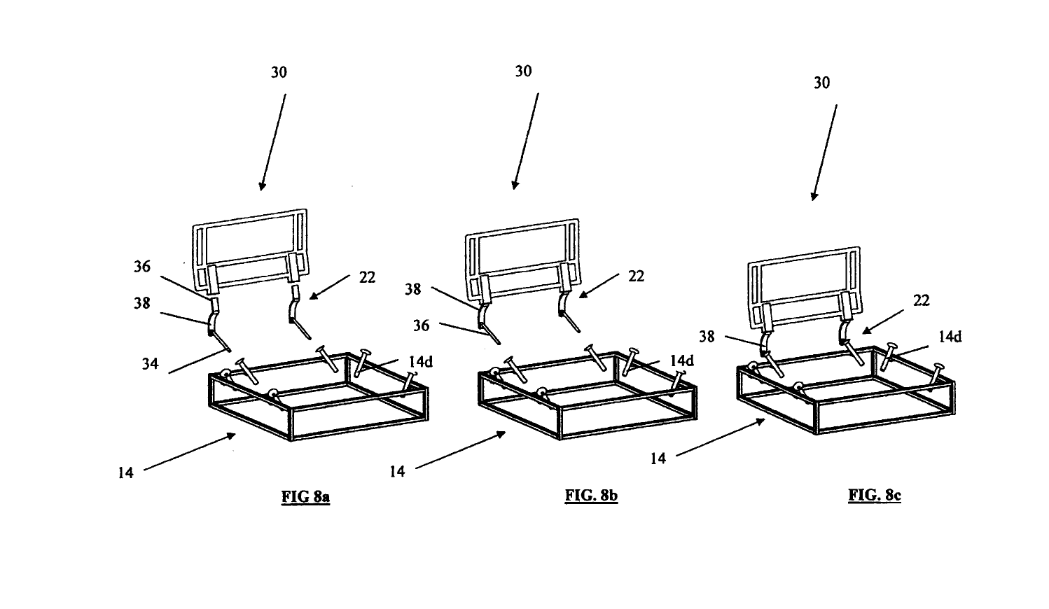

Referring now to FIGS. 7 and 8 of the drawings, another embodiment of the article of furniture in the form of a lounge unit 10 is described. With reference to the previous drawings, like reference numerals refer to like parts unless otherwise specified.

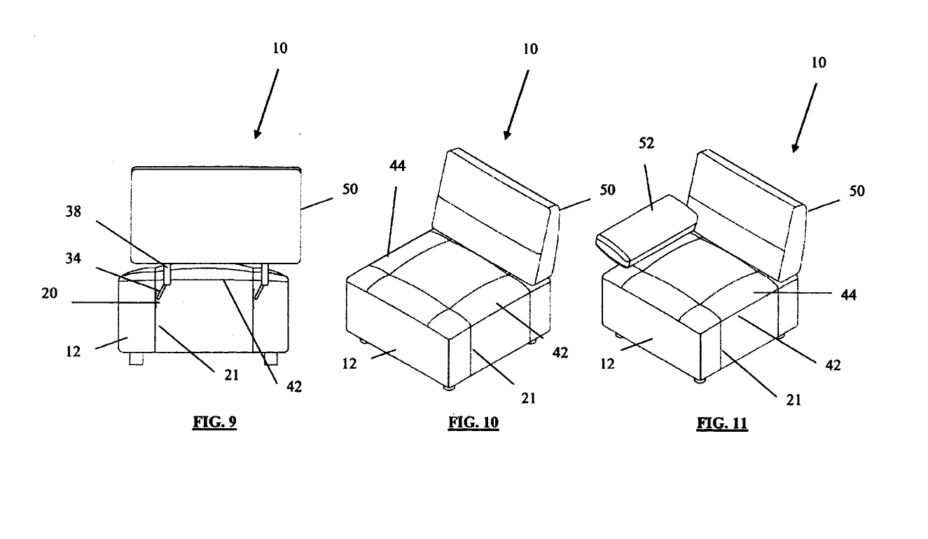

In this embodiment, each connector 22 comprises a first member in the form of a pin 34 (FIG. 8), a second member in the form of a tongue 36 and an intermediate, bridging portion 38 arranged between the pin 34 and the tongue 36. The bridging portion 38 has a contoured, curved part 40, to follow a contour of a part 42 (FIG. 9) of the seat portion 12. The part 42 of the seat portion is an upper part of the seat portion 12 where a top 44 of the seat portion 12 meets a side 46 of the seat portion 12.

The bridging portion 38 of the connector 22 includes a substantially planar part 48, formed integrally with, and at one end of the curved part 40 with the tongue 36 being arranged on the bridging portion 38 on an opposite end of the curved part 40 of the bridging portion 38. The tongue 36 is either formed integrally with the bridging portion as a one piece unit or, instead, the tongue 36 is a separate element secured, for example, by welding to the bridging portion 38 as shown in FIGS. 18a-18c of the drawings.

It will be appreciated that, because the tongue 36 is of a flat construction with the socket of the frame member 32a being correspondingly dimensioned, it inhibits rotation of the connector 22 relative to the seat portion and also provides greater load-bearing ability.

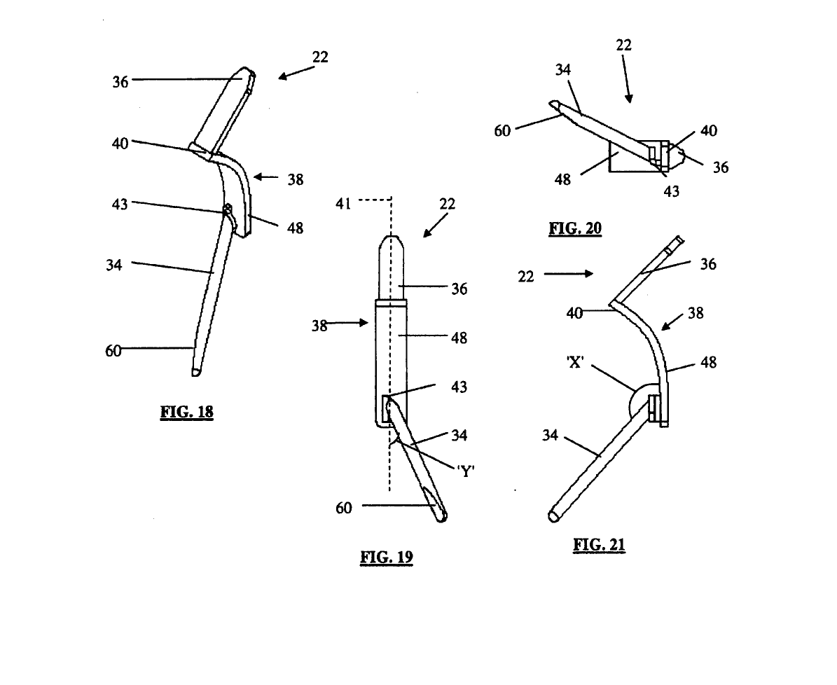

The pin 34 protrudes at an angle ‘X’ (FIG. 21) from the planar part 40 of the bridging part 38 of the connector 22. The angle is an obtuse angle and is typically about 100°-170°, more particularly, about 120°-160° and, optimally about 135°. Instead the angle could lie in one of the ranges from 100°-110°, 110°-120°, 130°-140°, 140°-150°, 150°-160°, 160°-170°. As shown in FIG. 19 of the drawings, the pin also projects at an acute angle ‘Y’ relative to a longitudinal axis 41 passing through the connector 22.

To accommodate the pin 34 of each connector 22, the frame 14 of the seat portion 12 includes frame elements 14d. Each frame element 14d is secured to one of the frame elements 14a at an angle complementary to the angle at which the pin 34 of the connector 22 projects from its associated bridging portion 38. Each frame element 14d is a socket defining member which defines a socket that is shaped to receive the pin 38 snugly. An access opening of each frame element is, once again, surrounded by the flared collar 14c to assist in guiding the pin 38 into the socket.

The connector includes a bracket 43 (FIGS. 18-21) via which the pin 34 is attached to the planar part 48 of the bridging portion 38 of the connector 22. The bracket 43 is an L-shaped bracket and defines a recess 45 in which the outer layer 18a of the covering 18 is received when the pin 34 is inserted into the opening 20 so as to minimise distortion of the covering 18, in use. It will be appreciated that, instead of the separate bracket 43, a head of the pin 34 could be fabricated, for example, by forging to have a shape substantially the same as that of the bracket 43.

This embodiment is particularly advantageous for attaching one or more backrest modules 50 (FIG. 10) and/or armrest modules 52 (FIG. 11) to the seating portion. It will, however, be appreciated that this embodiment could equally be used for attaching other modules such as side modules, table modules, rack modules, bookcase modules, or the like to the seating portion 12 of the article of furniture 10.

FIG. 10 shows an article of furniture 10 with a single backrest module 50 which can be used either as a chair or as a centre module in a modular sofa. FIG. 11 shows an article of furniture with a backrest module 50 and one armrest module 52 which is able to be used as a standalone chair or as an end module of a modular sofa. FIG. 12 shows an article of furniture with a backrest module 50 and two armrest modules 52 which is able to be used as an armchair. FIG. 13 shows an article of furniture having an oblong seating portion 12 with two backrest modules 50 and two armrest modules 52 to form a two seater sofa. It will be appreciated that it is also contemplated to provide a three seater sofa (not shown) having three backrest modules 50.

In the embodiment illustrated in FIGS. 7 and 8 above, a periphery of the flared collar 14c lies in a plane perpendicular to a longitudinal axis of the socket defining member or frame member 14d.

Another embodiment of the article of furniture is illustrated in FIGS. 15a and 15b. With reference to previous drawings, like reference numerals refer to like parts unless otherwise specified. In this embodiment, the periphery of the flared collar 14c lies in a plane substantially perpendicular to the first plane. This may assist in inserting the pin 34 of the connector 22 into its associated socket in certain circumstances.

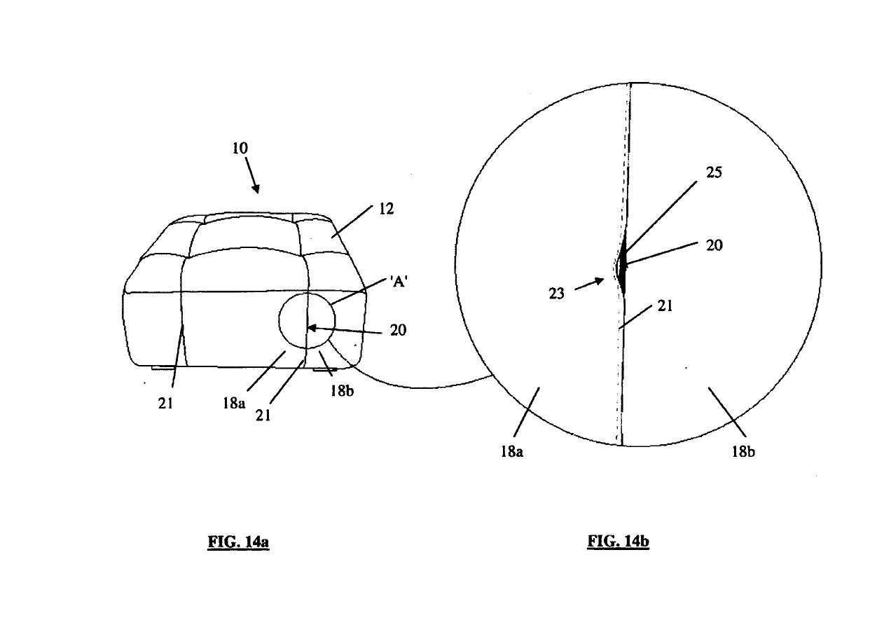

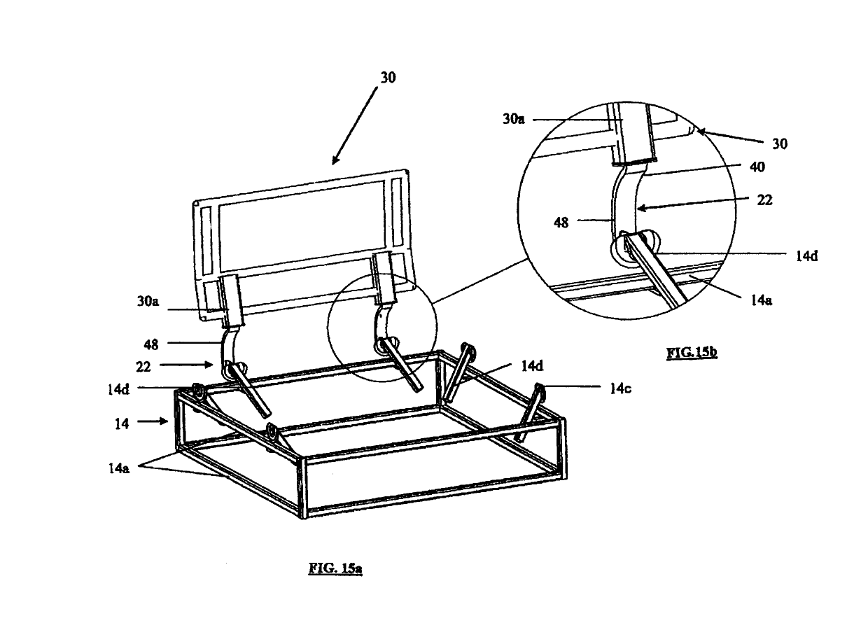

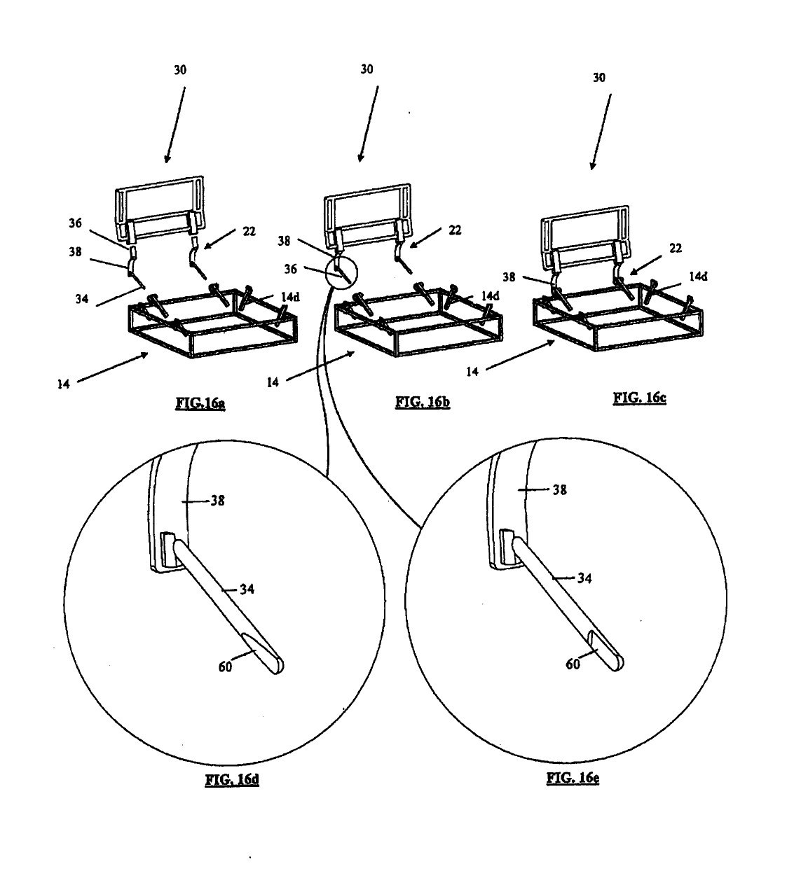

FIGS. 16a-16e show yet a further embodiment of the article of furniture and, once again, with reference to the previous drawings like reference numerals refer to like parts unless otherwise specified.

In this embodiment, a free end of each pin 34 is machined to have a flat 60, two different embodiments of the flats 60 being shown in FIGS. 16d and 16e of the drawings. The benefit of the flat 60 is that it inhibits the pin 34 rotating when the pin 34 is inserted into its associated socket.

It will be appreciated that, instead of the flat 60, inhibiting rotation of the pin 34 could be achieved in other ways, for example, by making the pin elliptical or polygonal in transverse cross-sectional shape either with or without flats with the socket being correspondingly shaped.

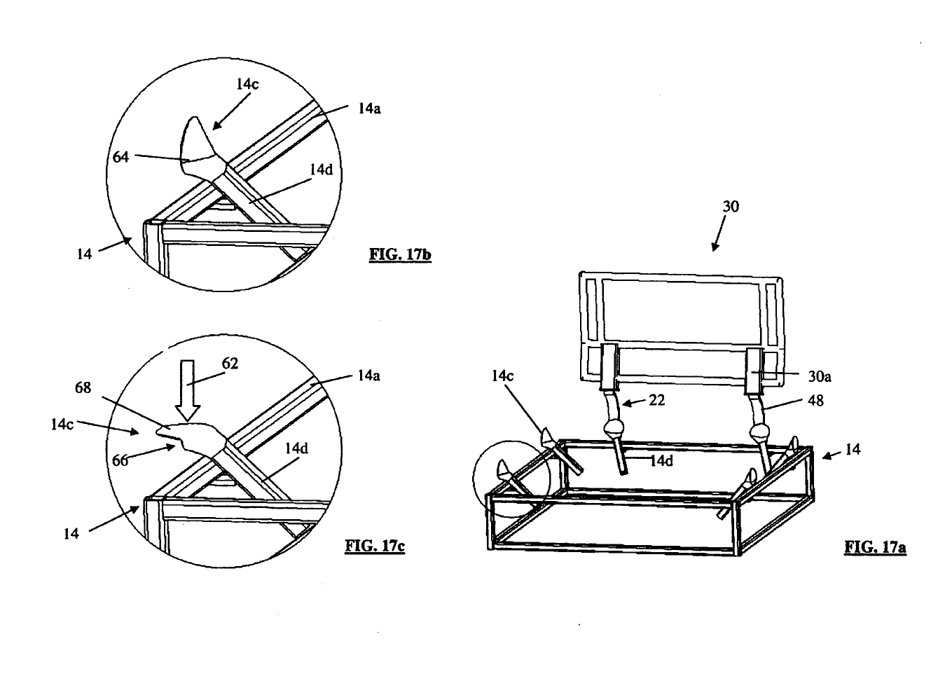

Referring now to FIGS. 17a-17c, yet a further embodiment of the article of furniture is illustrated. Yet again, with reference to previous drawings, like reference numerals refer to like parts unless otherwise specified.

In this embodiment, the periphery of the flared collar 14c, once again, lies in the first plane. In this embodiment, the flared collar 14c is of a resiliently flexible material of variable stiffness characteristics. As a result, when a force is applied in the direction of arrows 62 (FIG. 17c) the flared collar 14c deforms so that an operatively upper part, lies in a plane substantially parallel to the first plane. It will be appreciated that such a force would be generated by a person sitting on the seat portion 12. The flexibility of the collar 14c reduces the likelihood of the collar 14c digging in to the person.

To achieve the deformation of the collar 14c in the predetermined manner, the portion of the collar 14c above imaginary line 64 and a part of the collar 14c immediately connected to the frame element 14d is of a first stiffness. An intermediate part, in the region of transition 66 is of a second, lower stiffness. Thus, when the collar 14c deforms under the effect of the force, a substantially planar tab-like part 68 is formed which extends substantially parallel to the first plane as shown in FIG. 17c of the drawings. Removal of the force results in the collar 14c springing back to its undeformed state as shown in FIG. 17b of the drawings.

Yet another issue which the applicant has identified is that, in some cases, users do not insert the connectors 22 all the way into the sockets of the frame 14 of the seat base 12 and/or the frame member 30 To alleviate, this, a stop arrangement (not shown) is included which indicates that the pin 34 and/or the tongue 36 are inserted fully home into their associated sockets. Each stop arrangement may be in the form of a retention clip, such as a circlip or R-clip mounted on the relevant socket defining member to engage a peripheral groove in the pin 34 or tongue 36, as the case may be. Instead, the stop arrangement may be a stop point incorporated into the relevant socket and against which the pin 34 or tongue 36 strikes audibly so that a person assembling the article of furniture knows that the pin 34 or tongue 36 is fully home.

It will be appreciated by persons skilled in the art that numerous variations and/or modifications may be made to the above described embodiments without departing from the broad general scope of the present disclosure. The above embodiments are, therefore, to be considered in all respects as illustrative and not restrictive. Examples of possible variations and/or modifications include, but are not limited to:
disguising the opening as a buttonhole or eyelet in the upholstery;
the removable module may be a table, rack, bookcase or armrest module.

1. An article of furniture comprising:
a seat portion having a frame and upholstery covering the frame, the upholstery including cushioning and a covering overlying the cushioning;
at least one opening defined at least in the covering of the upholstery, the at least one opening being configured to receive a component of a connector arrangement to attach a removable module to the frame; and
a disguising member disguising the at least one opening, the disguising member being configured as a feature of the upholstery.

2. The article of furniture of claim 1 in which the disguising member is a feature of the covering of the upholstery.

3. The article of furniture of claim 1 in which the disguising member is selected from the group consisting of: a seam, a button and buttonhole, an eyelet, a belt loop, a zip and a strap.

4. The article of furniture of claim 3, in which, where the disguising member is a seam, the covering of the upholstery defines an overlapping portion having an outer layer and an inner layer so that, at least at a part of the overlapping portion, the outer layer is not stitched to the inner layer so that the opening is an aperture in the covering, the aperture being covered by the outer layer.

5. The article of furniture of claim 4 in which the outer layer and the inner layer are biased towards each other to facilitate displacement of the outer layer over the inner layer to hide the aperture upon removal of the component of the connector arrangement.

6. The article of furniture of claim 5 which includes a retention arrangement carried by the covering for retaining the outer layer over the inner layer when the component of the connector arrangement is absent.

7. The article of furniture of claim 1 which includes at least one removable module and a connector arrangement associated with each removable module.

8. The article of furniture of claim 7 in which the, or each, module has a frame member associated with it.

9. The article of furniture of claim 8 in which the connector arrangement comprises at least one component, in the form of a connector, for interconnecting the frame of the seat portion and the frame member of the relevant module.

10. The article of furniture of claim 9 in which the connector arrangement comprises at least two connectors which, in use, are arranged in spaced relationship relative to each other.

11. The article of furniture of claim 9 in which the connector is elongate, having a first arm, an opposed second arm and an intermediate, bridging portion between the first arm and the second aim.

12. The article of furniture of claim 11 in which the first arm and the second arm of the connector extend longitudinally and substantially parallel to each other and the bridging portion of the connector extends transversely with respect to the arms to form a cranked element.

13. The article of furniture of claim 8 in which the frame is a box frame and comprises frame elements extending generally parallel to a first plane, which, in use, is a substantially horizontal plane, and frame elements extending generally perpendicularly to the first plane.

14. The article of furniture of claim 13 in which the frame of the seat portion and the frame member of the module contain socket defining members which define sockets for receiving the arms of the connector.

15. The article of furniture of claim 13 in which the frame of the seat portion and the frame member of the module define sockets for receiving the arms of the connector.

16. The article of furniture of claim 14 in which an inlet to each socket defining member is flared or contain a flared collar to aid in insertion of the relevant arm into a socket of its associated socket defining member.

17. The article of furniture of claim 13 in which the socket defining members extend substantially perpendicularly to the first plane of the frame.

18. The article of furniture of claim 16 in which the socket defining members are arranged at an angle to the first plane of the frame.

19. The article of furniture of claim 18 in which an outer periphery of the collar of each socket defining member lies in a plane substantially perpendicular to a longitudinal axis of the socket.

20. The article of furniture of claim 18 in which an outer periphery of the collar lies in a plane substantially perpendicular to the first plane of the frame of the seat portion.

21. The article of furniture of claim 18 in which the collar is flexible to deform when a force is applied to it.

22. The article of furniture of claim 21 in which the collar is of a synthetic plastics material and is configured to have variable stiffness characteristics to deform in a predetermined manner when the force is applied to it and to return to its undeformed configuration when the force is removed.

23. The article of furniture of claim 9 in which each connector comprises a first member, in the form of a pin, a second member, in the form of a tongue, and an intermediate, bridging portion arranged between the first member and the second member.

24. The article of furniture of claim 23 in which the bridging portion comprises a contoured part to follow a contour of a part of the seat portion.

25. The article of furniture of claim 23 in which the bridging portion further includes a substantially planar part from which the pin extends.

26. The article of furniture of claim 25 in which the pin extends at a predetermined obtuse angle from the planar part of the bridging portion.

27. The article of furniture of claim 26 in which the pin is mounted via a bracket on the planar part of the bridging portion.

28. The article of furniture of claim 26 in which the pin is fabricated to have a head configured to accommodate a part of the covering to inhibit distortion of the covering.

29. The article of furniture of claim 23 in which the pin of the connector is shaped to inhibit rotation relative to the socket in which it is received.

30. A component for an article of modular furniture, the component including
an elongate tubular element defining a socket in which a spigot is receivable; and
a collar arranged at an entrance opening to the tubular member, the collar being flexible to deform in a predetermined manner when a force is applied to it.

31. The component of claim 30 in which the collar is of a synthetic plastics material and is configured to have variable stiffness characteristics to deform in a predetermined manner when the force is applied to it and to return to its undeformed configuration when the force is removed.
